(19) United States
(12) Patent Application Publication
(10) Pub. No.: US 2015/0240908 A1
(43) Pub. Date: Aug. 27, 2015

(54) Vibration-Dampening Rod

(71) Applicant: HUTCHINSON, Paris (FR)

(72) Inventors: Thierry Pizanti, La Ferte Villeneuil (FR); Manfred Stahl, Langey (FR); Pascal Petit, Beaugency (FR); Antony Ledoux, La Chapelle Saint Mesnin (FR)

(21) Appl. No.: 14/633,439

(22) Filed: Feb. 27, 2015

(30) Foreign Application Priority Data
Feb. 27, 2014 (FR) 14 51612

(51) Int. Cl. F16F 15/08; F16M 13/02

(52) U.S. Cl. CPC F16F 15/08; F16M 13/02

(57) ABSTRACT

Vibration-dampening rod comprising a rod body connecting first and second joints. The second joint comprises a ring having a central axis and comprising a through-window, an inner frame surrounded by the ring, and an elastomeric body overmolded on the inner frame and on the inside of the ring, molded as one piece and extending over a major portion of the axial height of the ring. The rod body traverses the window of the ring and is fixed to the inner frame.

### FIELD OF INVENTION

The present invention relates to vibration-dampening rods, particularly those for motor vehicles.

### BACKGROUND OF THE INVENTION

More particularly, the invention relates to a vibration-dampening rod having first and second joints and a rigid rod body extending between first and second ends respectively connected to the first and second joints, the second joint comprising:
a rigid ring having a central axis and extending for a certain axial height, the ring comprising a through-window,
a rigid inner frame surrounded by the ring,
and an elastomeric body overmolded on the inner frame and on the inside of the ring,
   said rod body traversing said window and the second end of the rod body being fixed to the inner frame.

Document EP-A-1247678 discloses an example of a joint of this type, which is part of a vibration-dampening rod where the rigid rod body traverses said window to attach to the inner frame. In this known joint, the elastic connection comprises two elastomeric bodies which are axially superimposed along the central axis and are respectively overmolded on two inner frames.

This joint has the following drawbacks:
the manufacturing process is relatively expensive because it involves two molding operations to produce the two elastomeric bodies,
the vibration damping of the joint is limited, because the amount of elastomer that can be used in the elastic connection between the inner frame and the ring is relatively small due to being produced as two separately molded parts.

### OBJECTS AND SUMMARY OF THE INVENTION

The present invention is intended to overcome these disadvantages.

According to the invention, a vibration-dampening joint of the kind in question is characterized in that said elastomeric body is molded as one piece and extends over a major portion of the axial height of the ring, including at the window.

“Molded as one piece” is understood to mean molded in a single molding operation, even if there is discontinuity of material between various portions of the elastomeric body.

With these arrangements, it is no longer necessary to use two elastomeric bodies that are separately molded and then assembled to connect the inner frame to the ring. This results in savings in the joint production cost, and in better vibration-damping efficiency because the elastic connection can contain more elastomeric material within the space available inside the ring.

In preferred embodiments of the joint according to the invention, one or more of the following arrangements may possibly be used:
the elastomeric body comprises two arms arranged in a V and respectively extending in a diverging manner from first ends overmolded on the inner frame, to second ends overmolded on the inside of the ring on each side of the window;
the inner frame comprises a frame body extending substantially perpendicularly to the central axis of the ring and two side fins arranged one on either side of the second end of the rod body, said side fins extending parallel to the central axis and having outer surfaces on which are overmolded the first ends of the arms of the elastomeric body, said outer surfaces of the side fins diverging away from the ring window;
the inner frame further comprises a rear wall extending along the central axis and interconnecting said side fins opposite the ring window, said rear wall defining, together with the frame body and the side fins, a rod body housing into which the second end of the rod body is fitted;
the second end of the rod body is traversed by a screw that secures the inner frame to a rigid insert, the second end of the rod body being clamped between the insert and the frame body by said screw;
the insert comprises an insert body which extends substantially perpendicularly to the central axis and two fingers which extend along the central axis, the insert body being clamped by the screw against the second end of the rod body and being fitted into an insert housing defined by the side fins and rear wall of the inner frame, the fingers being arranged substantially as an extension of the side fins toward the window, and the frame body comprising a front portion arranged near said window, said front portion being nested with the second end of the rod body between the fingers of the insert;
the insert body comprises a rear portion arranged near the rear wall of the inner frame, said rear portion of the insert body comprising two outer side surfaces diverging toward said rear wall, the side fins and the rear wall of the inner frame together defining an insert body housing having a shape complementary to the rear portion of the insert body and said rear portion of the insert body nesting within it, the rod body housing being delimited between two parallel inner side surfaces that are part of the side fins of the inner frame, the second end of the rod body comprising two parallel outer side surfaces extended by two converging outer side surfaces which converge toward the first end of the rod body, the parallel outer side surfaces of the second end of the rod body nesting between the inner side surfaces which define the rod body housing and the converging outer side surfaces of the second end of the rod body nesting between the fingers of the insert, which have a shape complementary to said converging outer side surfaces.

### BRIEF DESCRIPTION OF DRAWINGS

Other features and advantages of the invention will become apparent from the following description of one of its embodiments, given by way of non-limiting example with reference to the accompanying drawings.

In the drawings:

FIG. 1 is a schematic view showing a possible application of a vibration-dampening rod according to one embodiment of the invention, mounted in a vehicle,

FIG. 2 is a three-quarter perspective view from above, of a vibration-dampening rod according to the invention mounted on the vehicle body,

FIGS. 3 and 4 are perspective views of the rod of FIG. 2 when disassembled, respectively in a three-quarter view from above and a three-quarter view from below,

FIG. 5 is a perspective longitudinal section view of the rod of FIGS. 3 and 4,

FIGS. 6 and 7 are exploded views of the rod of FIGS. 3 and 4, respectively in a three-quarter view from above and a three-quarter view from below, showing the portion of the rod near the vehicle body,

and FIGS. 8 and 9 are perspective views of the inner frame of the rod joint connecting to the vehicle body, respectively showing this inner frame in a perspective three-quarter view from above and a perspective three-quarter view from below.

### MORE DETAILED DESCRIPTION

In the various figures, the same references designate identical or similar elements.

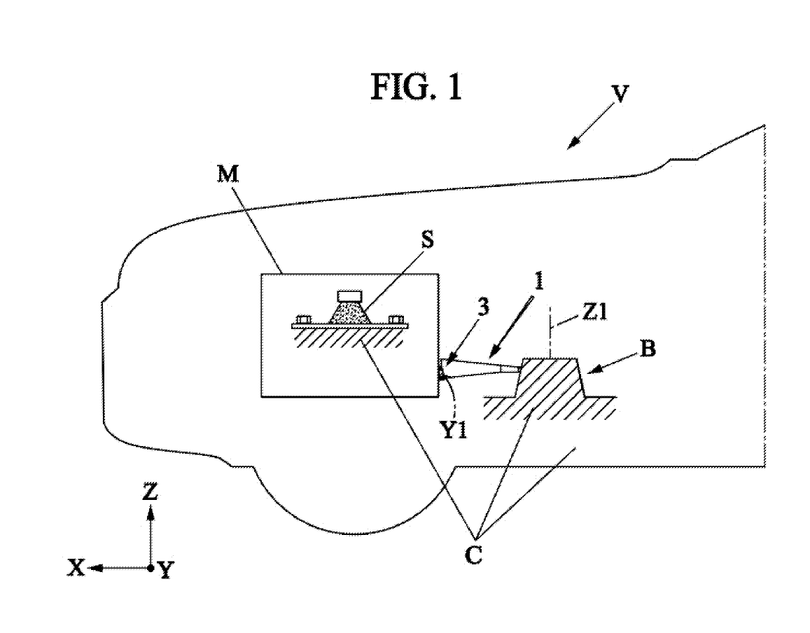

As is schematically represented in FIG. 1, the invention relates to a vibration-dampening rod 1, in particular a torque reaction rod for a motor vehicle V with an internal combustion engine.

The rod 1 may be pivotably connected:
to the engine M, about a transverse axis Y1 parallel to the transverse direction Y of the vehicle,
and to the body C of the vehicle, particularly to the subframe B, about a vertical axis Z1.

The rod 1 is adapted to damp torque from the engine M when the engine is mounted on the body C by a suspension comprising, for example, two vibration-damping engine mounts S aligned in the transverse direction Y of the vehicle.

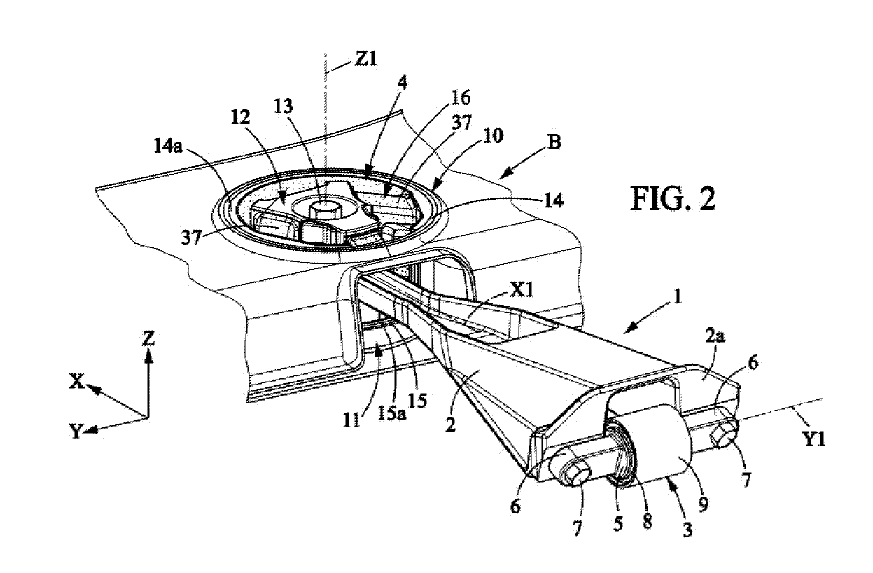

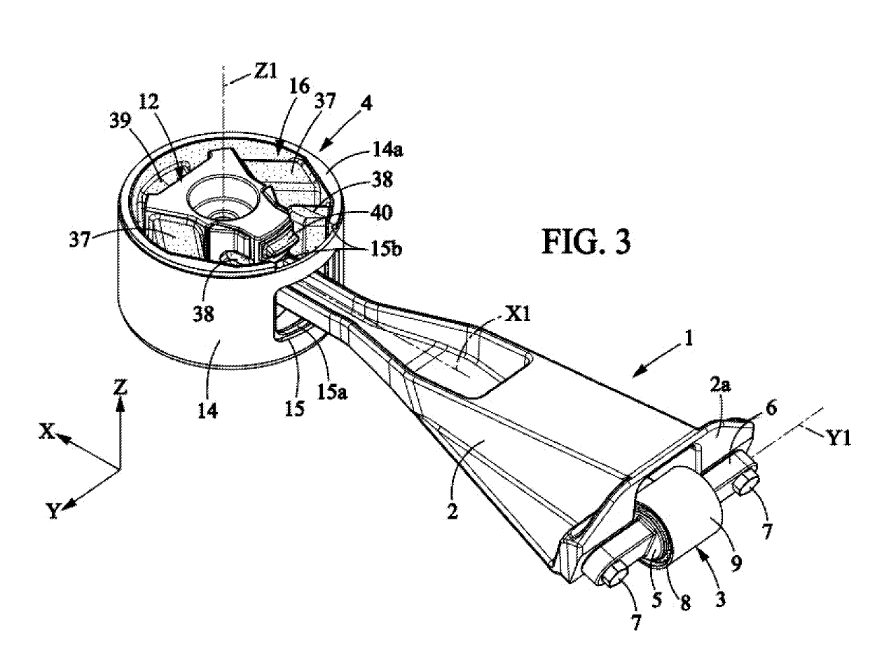

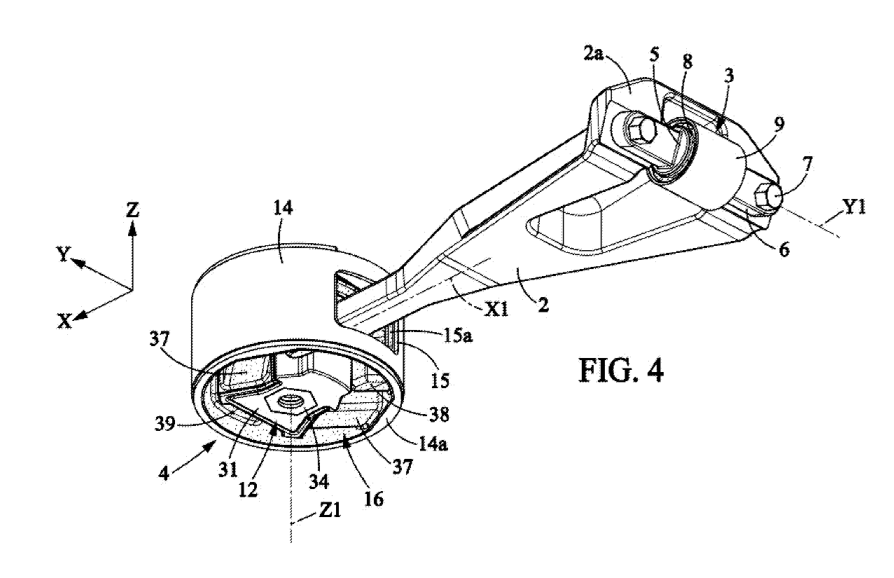

As represented in FIGS. 2 to 5, the rod 1 comprises a rigid rod body 2 which extends longitudinally between first and second ends 2a, 2b respectively connected to first and second vibration-dampening joints 3, 4.

The rod body may be made for example of metal, in particular a light alloy. It extends longitudinally in a direction X1 which may be, for example, substantially parallel to the longitudinal direction X of the vehicle.

The first joint 3 may be attached for example to the engine M and have an axis of rotation Y1 as indicated above. This first joint may comprise:
a rigid inner frame 5 made for example of metal,
a rigid outer ring 9 made for example of metal and surrounding the inner frame 5,
and an elastomeric body 8 interposed between the inner frame and the outer ring.

In the current example, the outer ring 9 of the first joint is intended to be fitted into a cylindrical housing of a support member connected to the engine M, while the inner frame 5 is extended at its axial ends by two attachment tabs 6 attached to the first end 2a of the rod body, for example by means of screws 7.

The second joint 4 may be, for example, fitted into a well 10 of axis Z1 that is part of the subframe for mounting the engine, with the rod body 2 traversing a side opening 11 formed in said subframe B.

The second joint 4 comprises:
a rigid inner frame 12, connected to the second end 2b of the rod body for example by a screw 13,
a rigid outer ring 14, 15 of central axis Y1, surrounding the inner frame, the ring having a through-window 14a, 15a, 15b which the rod body 2 traverses,
and an elastomeric body 16 overmolded on the inner frame 12 and on the inside of the ring 14, 15.

In the example shown, the inner frame 12 may be a molded piece, for example of plastic or light alloy.

The outer ring 14, 15 could be formed as a single piece; in the example considered here it is formed as two concentric annular pieces, an outer ring 14 and an inner ring 15 secured to the outer ring 14 by any known means. The outer ring 14 may be, for example, of metal and the inner ring 15 may be, for example, molded of plastic and snapped into the outer ring after the elastomeric body 16 is molded in the inner ring 15. The aforesaid window of the inner ring 15 may, for example, be formed as a U-shaped cut having a base 15a and two side edges 15b, which facilitates snapping in place.

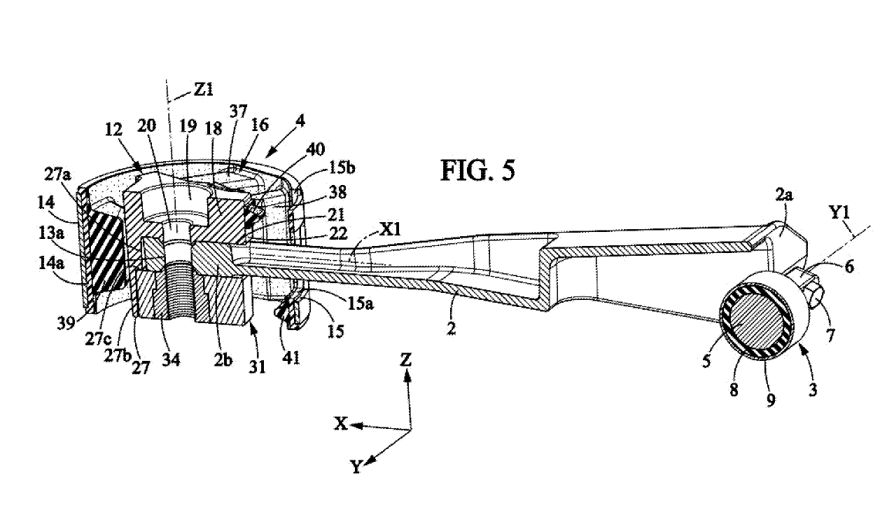

As can be seen in more detail in FIGS. 5-9, the inner frame 12 may comprise a relatively thick and flat frame body 18, extending substantially in a plane X, Y perpendicular to the central axis Z1 of the ring 14, 15.

The frame body 18 may have a recess 19 on its main outer face (the upper face here), for receiving the head of the screw 13, which opens into a through-hole 20 extending along the central axis Z1 and which receives the screw 13. The main inner face 21 (the lower face here) of the frame body 18 is preferably a flat face perpendicular to the central axis Z1.

The frame body 18 has a front face 22 oriented in direction X facing toward the rod body 2 and here arranged facing the cutout 15a, 15b of the inner ring 15, above the window 14 of the outer ring 14.

This front face 22 is extended rearward (meaning away from the window 14a, 15a, 15b) by two opposing side faces 23 defining a front portion of the frame body 18. These side faces 23 may advantageously be shaped to diverge rearwardly. The side faces 23 are themselves extended rearwardly by two opposing side faces 24 which also diverge rearwardly and which join a rear wall 25 opposite the front wall 22. The side walls 24 are extended downward, parallel to the central axis Z1, by two side fins 26 which are also shaped to present rearwardly diverging outer surfaces. The inner frame 12 further comprises a rear wall 27 which also extends downward along the central axis Z1, and which interconnects said side fins 26.

The side fins 26 comprise, under the inner face 21 of the frame body, parallel inner side surfaces 26a extending in plane X, Z, and the rear wall has a first inner surface 27a extending in plane Y, Z, to fit with these parallel inner surfaces 26a. These inner surfaces 26a, 27a together with the inner face 21 of the frame body 18 define a rod body housing into which is fitted, along axis X1, the second end 2a of the rod body.

The side fins 26 may further comprise, under the parallel inner side surfaces 26a, diverging inner side surfaces 26b which diverge rearwardly and which are separated from the inner side surfaces 26a by downward-facing shoulders 26c. The rear wall 27 may itself have a second inner surface 27b separated from the first inner surface 27a by a downward-facing shoulder 27c. These inner surfaces 26b, 27b define an insert housing receiving a rigid insert 31.

The insert 31, which is clearly visible in FIGS. 5 to 7, may be a molded piece, for example made of plastic.

The insert 31 may comprise an insert body 32 which is substantially flat and which extends substantially perpendicularly to the central axis Z1.

The insert body 32 comprises a front portion 32a and a rear portion 32b. The rear portion 32b has two outer side surfaces 33b diverging rearwardly. This rear portion 32b fits without play into the insert body housing mentioned above. The insert body 32 is overmolded onto a nut 34 of steel or other material, into which the screw 13 mentioned above is screwed.

The insert body 32 further comprises a flat inner surface 35 (an upper surface here) parallel to the inner surface 21 of the frame body 18. These inner surfaces 21, 35 are clamped against the second end 2b of the rod body by tightening the screw 13.

The front portion 32a of the insert body 32 may also have rearwardly diverging outer side surfaces 33a, which are extended along the central axis Z1 by two upwardly extending fingers 36. The fingers 36 of the insert 31 may advantageously be arranged substantially as the frontward extension of the side fins 26 and shaped to provide rearwardly diverging inner surfaces 36a, fitting with the side surfaces 23 of the front part of the frame body 18.

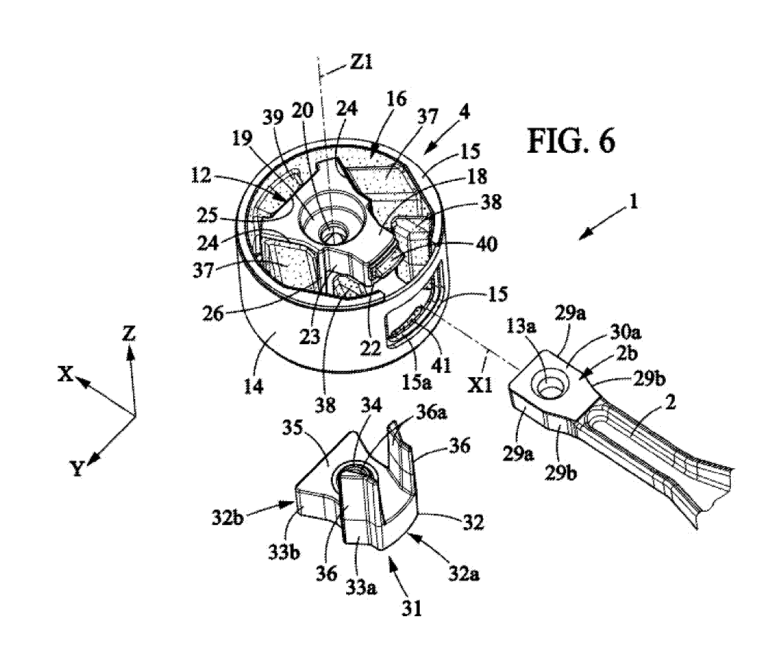

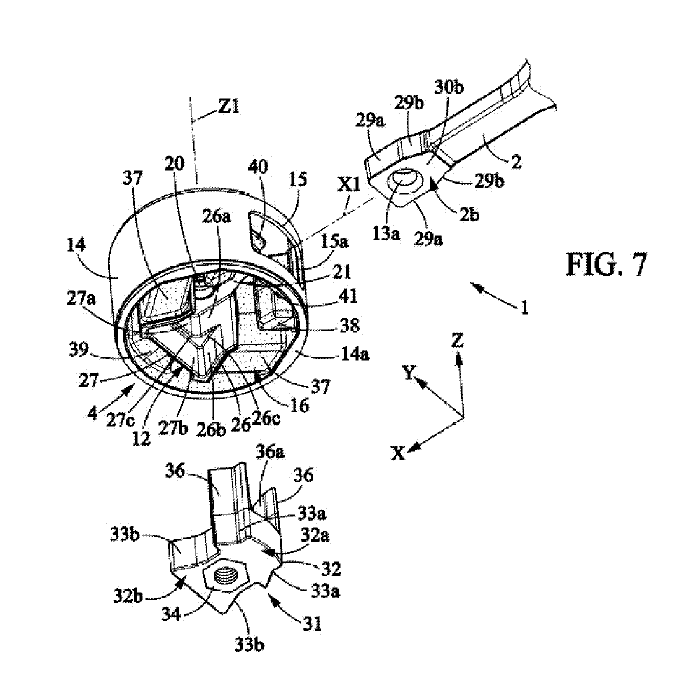

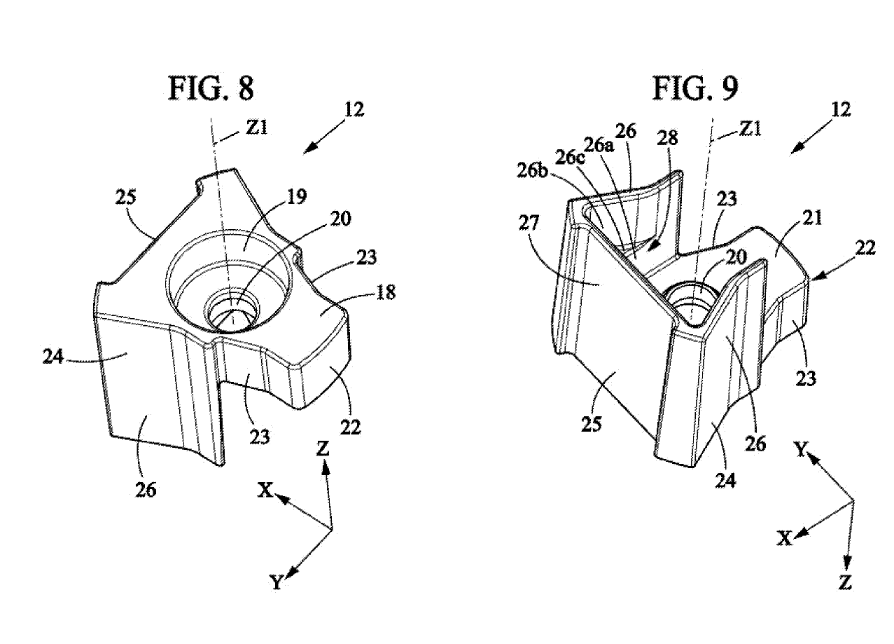

As shown in FIGS. 6 and 7, the second end 2b of the rod body is advantageously shaped to correspond to said rod body housing defined by surfaces 26a, 27a, 21, 35, and fits without play into said housing. This second end 2b comprises:
two parallel outer side surfaces 29a which are in contact with the parallel inner surfaces 26a,
two converging outer side surfaces 29b respectively extending the parallel outer side surfaces 29a toward the first end 2a of the rod body and engaging with the converging inner surfaces 36a of the fingers 36,
two parallel main faces 30a, 30b, flat and perpendicular to the central axis Z1, which are traversed by said hole 13a and which are clamped between the inner surfaces 21, 35 that are respectively a part of the inner frame 12 and of the insert 31.

Due to the design of the second end 2b of the rod body, the inner frame 12, and the insert 31, the connection between these parts is particularly strong.

As is shown in more detail in FIGS. 5 to 7, the elastomeric body 16 is molded as one piece and extends over a major portion of the axial height of the ring 14, 15, including at the window 14a, 15b, 14c of said ring.

The elastomeric body 16 comprises two arms 37 arranged in a V and extending forward in a diverging manner in plane X, Y, respectively from first ends respectively overmolded on the outer surfaces of the side fins 26, to second ends overmolded inside the ring on each side of the window. The second ends of the arms 37 are preferably overmolded on the inner surface of the inner ring 15 in the example considered here.

In the example shown, the elastomeric body forms a thin layer of elastomer that is substantially continuous inside the ring 15 and on the outside of the inner frame 12, so that there is continuity of material between the two arms 37. However, there may be discontinuity of material between the two arms 37: the term “molded as one piece” should be understood here to mean that the two arms 37 are molded in a single molding operation.

Due to this single-molding design, the cost price of the second joint 4 is reduced and this second joint can provide improved vibration-damping efficiency because the amount of elastomer that can be used within the space available inside the ring 14, 15 is increased.

The elastomeric body may further comprise stops 38-41, for example:

two lateral front stops 38 arranged inside the ring 15 between the arms 37 and adapted to cooperate by abutment against the outer faces of the fingers 36 of the insert 31,
and/or a rear stop 39 arranged inside the ring 15, opposite the window 14a, 15a, 15b, and adapted to cooperate by abutment against the rear wall 27 of the inner frame 12,
and/or a front stop 40 formed on the front face 22 of the frame body 18 and adapted to cooperate by abutment against the inner surface of the ring 14 above the window 14a,
and/or a front stop 41 formed inside the ring 15 below the window 14a and adapted to cooperate by abutment against the front portion 32a of the insert 31.

The front stops 40, 41 are preferably offset along axis X1 so that they have no overlapping areas, to facilitate molding.

1. A vibration-dampening rod having first and second joints and a rigid rod body extending between first and second ends respectively connected to the first and second joints, the second joint comprising:
a rigid ring having a central axis and extending for a certain axial height, the ring comprising a through-window,
a rigid inner frame surrounded by the ring,
and an elastomeric body overmolded on the inner frame and on the inside of the ring,
said rod body traversing said window and the second end of the rod body being fixed to the inner frame,
wherein said elastomeric body is molded as one piece and extends over a major portion of the axial height of the ring, including at said window.

2. The vibration dampening rod according to claim 1, wherein the elastomeric body comprises two arms arranged in a V and respectively extending in a diverging manner from first ends overmolded on the inner frame, to second ends overmolded on the inside of the ring on each side of the window.

3. The vibration-dampening rod according to claim 2, wherein the inner frame comprises a frame body extending substantially perpendicularly to the central axis of the ring and two side fins arranged one on either side of the second end of the rod body, said side fins extending parallel to the central axis and having outer surfaces on which are overmolded the first ends of the arms of the elastomeric body, said outer surfaces of the side fins diverging away from the ring window.

4. The vibration-dampening rod according to claim 3, wherein the inner frame further comprises a rear wall extending along the central axis and interconnecting said side fins opposite the ring window, said rear wall defining, together with the frame body and the side fins, a rod body housing into which the second end of the rod body is fitted.

5. The vibration-dampening rod according to claim 4, wherein the second end of the rod body is traversed by a screw that secures the inner frame to a rigid insert, the second end of the rod body being clamped between the insert and the frame body by said screw.

6. The vibration-dampening rod according to claim 5, wherein the insert comprises an insert body which extends substantially perpendicularly to the central axis and two fingers which extend along the central axis, the insert body being clamped by the screw against the second end of the rod body and being fitted into an insert housing defined by the side fins and rear wall of the inner frame, the fingers being arranged substantially as an extension of the side fins toward the window, and the frame body comprising a front portion arranged near said window, said front portion being nested with the second end of the rod body between the fingers of the insert.

7. The vibration -dampening rod according to claim 6, wherein the insert body comprises a rear portion arranged near the rear wall of the inner frame, said rear portion of the insert body comprising two outer side surfaces diverging toward said rear wall, the side fins and the rear wall of the inner frame together defining an insert body housing having a shape complementary to the rear portion of the insert body and said rear portion of the insert body nesting within it, the rod body housing being delimited between parallel inner side surfaces that are part of the side fins of the inner frame, the second end of the rod body comprising two parallel outer side surfaces extended by two converging outer side surfaces which converge toward the first end of the rod body, the parallel outer side surfaces of the second end of the rod body nesting between the inner side surfaces which define the rod body housing and the converging outer side surfaces of the second end of the rod body nesting between the fingers of the insert, which have a shape complementary to said converging outer side surfaces.
